(19) United States
(12) Patent Application Publication
(10) Pub. No.: US 2026/0131642 A1
(43) Pub. Date: May 14, 2026

(54) REINFORCEMENT STRUCTURE FOR CARGO INTRUSION OF CENTERGATE

(71) Applicants: Hyundai Motor Company, Seoul (KR); Kia Corporation, Seoul (KR)

(72) Inventors: Eric Hsu, Superior Township, MI (US); Farah Najem, Superior Township, MI (US); Kihyun Cho, Superior Township, MI (US); Jacob Tonks, Superior Township, MI (US); Basavaraj Koraddi, Superior Township, MI (US); Dhananjay More, Superior Township, MI (US); Harsha Kusnoorkar, Superior Township, MI (US)

(21) Appl. No.: 18/947,796

(22) Filed: Nov. 14, 2024

(51) Int. Cl. B60J 5/10; B60J 5/12

(52) U.S. Cl. CPC B60J 5/108; B60J 5/12; B60Y 2200/14

(57) ABSTRACT

A centergate system is provided. The centergate system may comprise a vehicle comprising a cab portion and a bed portion, and a centergate, positioned between the cab portion and the bed portion. The centergate may comprise a centergate panel, and, housed within the centergate panel, a left-hand hinge reinforcement assembly and a right-hand hinge reinforcement assembly, a left-hand latch reinforcement and a right-hand latch reinforcement, and an impact beam positioned between, and coupled to, the left-hand hinge reinforcement assembly and the right-hand hinge reinforcement assembly. The left-hand reinforcement assembly and the right-hand reinforcement assembly may be coupled to left and/or right sides of the centergate and a lower side of the centergate.

### BACKGROUND

### Technical Field

Embodiments of the present disclosure relate to reinforcement structures for cargo intrusion of a centergate.

### Background

Pickup trucks comprise a cab area, configured to receive passengers, and a bed area, configured to store cargo. Some pickup trucks include a centergate portion positioned between the cab portion and the bed portion of the pickup truck. The centergate may comprise a door configured to open between the cab and the bed to increase the cargo-carrying capacity of the pickup truck.

The centergate, which increasing the cargo-carrying capacity of the pickup truck, also presents a weakened structure between the cab and the bed, increasing the risk of damage to the cab in the event of sliding cargo.

For at least these reasons, a centergate configured to increase protection of occupants of the cab in the event of movement and/or intrusion of in-bed cargo is needed.

### SUMMARY

According to an object of the present disclosure, a centergate system is provided. The centergate system may comprise a vehicle comprising a cab portion and a bed portion, and a centergate, positioned between the cab portion and the bed portion. The centergate may comprise a centergate panel, and, housed within the centergate panel, a left-hand hinge reinforcement assembly and a right-hand hinge reinforcement assembly, a left-hand latch reinforcement and a right-hand latch reinforcement, and an impact beam positioned between, and coupled to, the left-hand hinge reinforcement assembly and the right-hand hinge reinforcement assembly. The left-hand reinforcement assembly and the right-hand reinforcement assembly may be coupled to left and/or right sides of the centergate and a lower side of the centergate

According to an exemplary embodiment, the left-hand latch reinforcement assembly and the right-hand latch reinforcement assembly may be positioned between, and coupled to, the left-hand latch reinforcement assembly and/or the right-hand latch reinforcement assembly, the left-hand hinge reinforcement assembly and/or right-hand hinge reinforcement assembly, and/or a left-hand hinge support bracket and/or a right-hand hinge support bracket.

According to an exemplary embodiment, the left-hand latch reinforcement assembly and right-hand latch reinforcement assembly may be coupled, directly or indirectly, at an angle to the left-hand latch reinforcement assembly and/or right-hand latch reinforcement assembly, and the left-hand hinge reinforcement assembly and the right-hand hinge reinforcement assembly and/or a left-hand hinge support bracket and a right-hand hinge support bracket.

According to an exemplary embodiment, the impact beam may be positioned between, and coupled to, the left-hand latch reinforcement assembly and the right-hand latch reinforcement assembly.

According to an exemplary embodiment, the centergate may be configured to move between an open position and a closed position.

According to an exemplary embodiment, in the closed position, the centergate may be configured to form a barrier between the cab portion and the bed portion.

According to an exemplary embodiment, the centergate system may further comprise a hinge assembly configured to couple the centergate to the vehicle.

According to an exemplary embodiment, the hinge assembly may comprise a hinge and assist mechanism assembly configured to couple the centergate to the vehicle.

According to an exemplary embodiment, the hinge assembly may comprise an upper bracket and bushing, a lower bracket and bushing, and a torsion bar adjoining the upper bracket and bushing and the lower bracket and bushing, forming a hinge therebetween.

According to an exemplary embodiment, the centergate may further comprise a left-hand latch reinforcement and a right-hand latch reinforcement.

According to an exemplary embodiment, the centergate may further comprise a left-hand hinge reinforcement assembly and a right-hand hinge reinforcement assembly.

According to an exemplary embodiment, the centergate may further comprise a left-hand hinge support bracket and a right-hand hinge support bracket.

According to an exemplary embodiment, the centergate may further comprise one or more striker assemblies.

According to an exemplary embodiment, the centergate may further comprise a left-hand latch assembly and a right-hand latch assembly.

According to an exemplary embodiment, the vehicle may comprise a pickup truck.

According to an object of the present disclosure, a centergate is provided. The centergate may comprise an outer and inner panel and, housed within the outer and inner panel, a left-hand hinge reinforcement assembly, a right-hand hinge reinforcement assembly, and an impact beam positioned between, and coupled to, the left-hand latch reinforcement assembly and the right-hand latch reinforcement assembly. The centergate may be configured to be positioned between a cab portion and a bed portion of a vehicle.

According to an exemplary embodiment, the centergate may be configured to move between an open position and a closed position.

According to an exemplary embodiment, the centergate may further comprise a hinge assembly configured to enable the centergate to be coupled to the vehicle, the hinge assembly comprising an upper bracket and bushing, a lower bracket and bushing, and a torsion bar adjoining the upper bracket and bushing and the lower bracket and bushing, forming a hinge therebetween.

According to an exemplary embodiment, the centergate may further comprise a left-hand latch reinforcement and a right-hand latch reinforcement.

According to an exemplary embodiment, the impact beam may be coupled to the left-hand latch reinforcement, the right-hand latch reinforcement.

According to an exemplary embodiment, the centergate may further comprise a left-hand hinge support bracket and a right-hand hinge support bracket.

According to an exemplary embodiment, the centergate may further comprise one or more striker assemblies.

According to an exemplary embodiment, the centergate may further comprise a left-hand latch assembly and a right-hand latch assembly.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a rear view of a centergate, according to an exemplary embodiment of the present disclosure.

FIG. 2 illustrates a front view of a centergate, according to an exemplary embodiment of the present disclosure.

FIG. 3A illustrates a front view of a centergate comprising an assembly coupled thereto configured to configured to couple the centergate to the vehicle, according to an exemplary embodiment of the present disclosure.

FIG. 3B illustrates an exploded view of the centergate of FIG. 3A, according to an exemplary embodiment of the present disclosure.

FIG. 4 illustrates a sectional view of the centergate of FIG. 3A along section A-A, according to an exemplary embodiment of the present disclosure.

FIG. 5 illustrates a sectional view of the centergate of FIG. 3A along section B-B, according to an exemplary embodiment of the present disclosure.

FIG. 6 illustrates a hinge assembly of a centergate, according to an exemplary embodiment of the present disclosure.

FIG. 7 illustrates a pickup truck having a centergate coupled thereto, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, reinforcement structures for cargo intrusion of a centergate are provided.

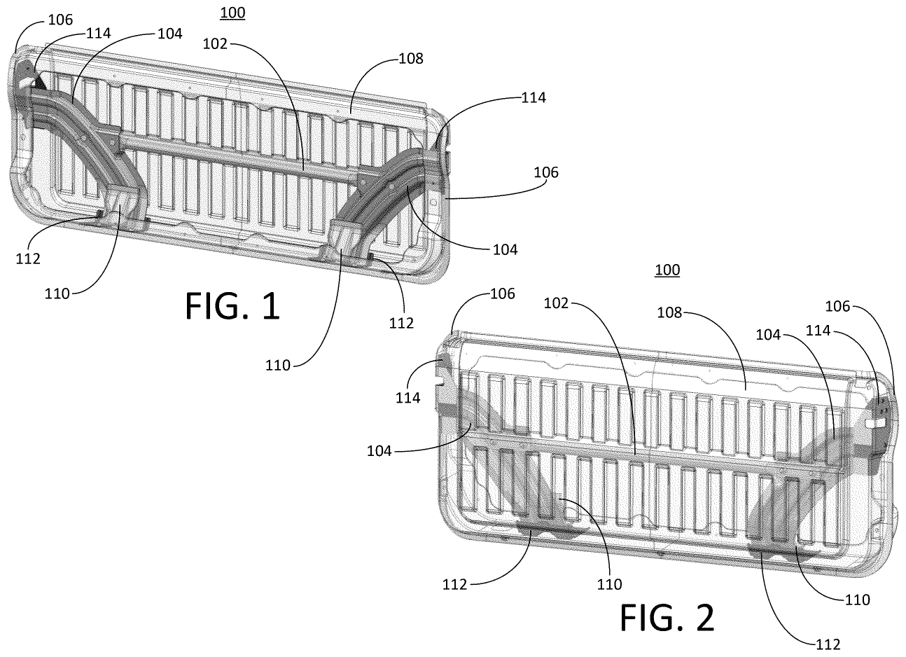

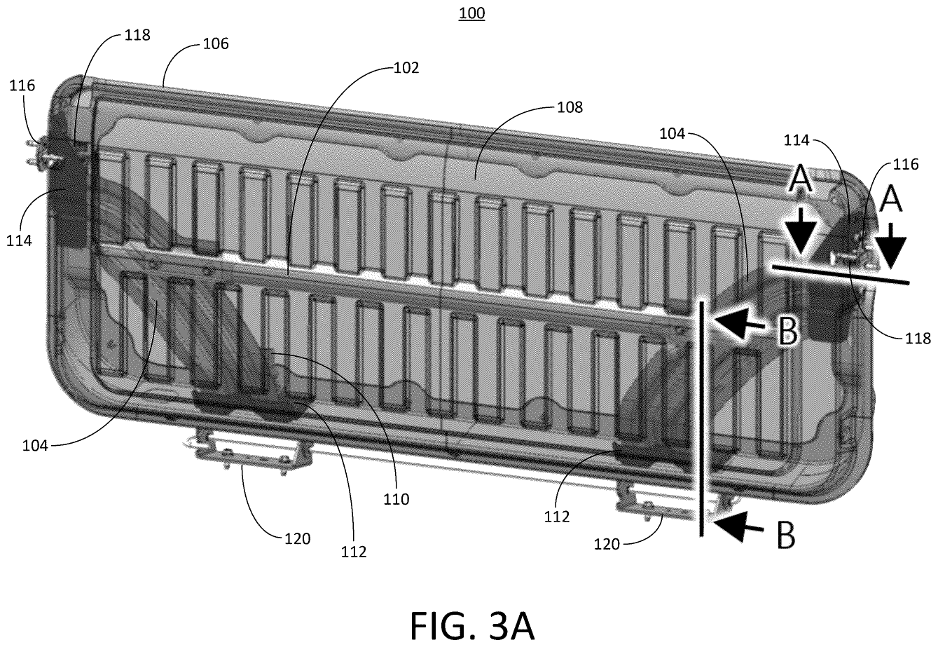

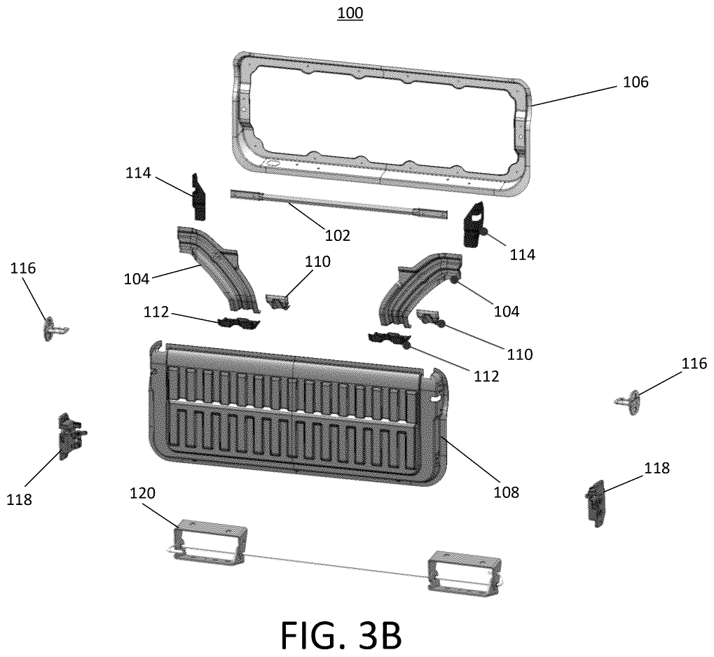

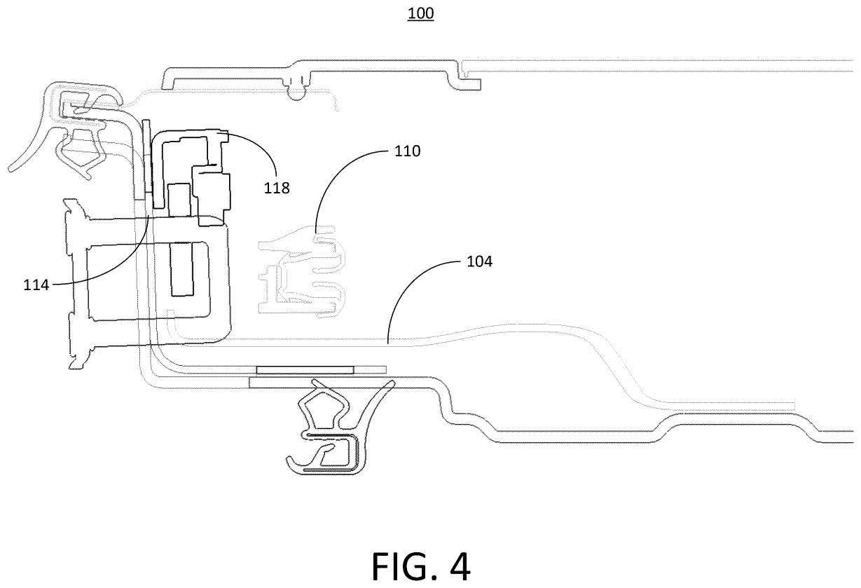

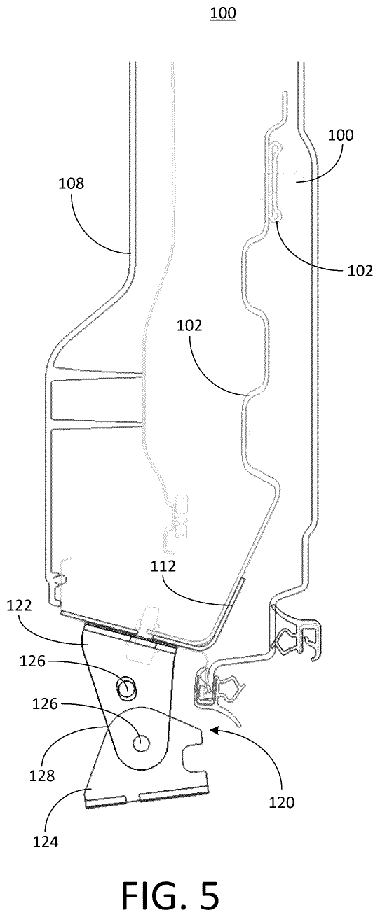

Referring now to FIGS. 1-5, a rear view (FIG. 1) and front view (FIG. 2) of a centergate 100, a front view (FIG. 3A) and exploded view (FIG. 3B) of a centergate 100 comprising an hinge and assist mechanism assembly 120 (e.g., a hinge and a spring assembly, a hinge and torsion assembly, a hinge assembly, and/or other suitable hinge and assist mechanism assembly) coupled thereto configured to couple the centergate 100 to a vehicle 130 (e.g., a pickup truck or other suitable vehicle), a sectional view (FIG. 4) of the centergate 100 of FIG. 3A along section A-A, and a sectional view (FIG. 5) of the centergate 100 of FIG. 3A along section B-B are illustratively depicted, in accordance with exemplary embodiments of the present disclosure.

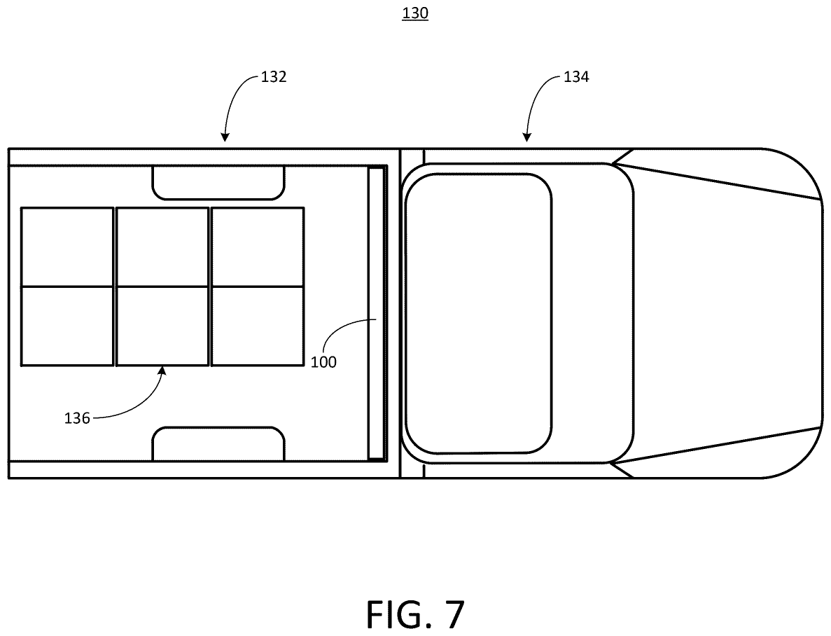

According to an exemplary embodiment, the centergate 100 is configured to be positioned between a bed portion 132 and cab portion 134 of a pickup truck 130 (as shown, e.g., in FIG. 7). According to an exemplary embodiment, the centergate 100 may be positioned along the pickup truck 130 such that the centergate 100 defines the edge of the internal cavity of the cab portion 134 and protects internal components as well as cab portion 134 occupants.

The centergate 100 may comprise a centergate panel 108, an inner panel 106, an impact beam 102, a left-hand and right-hand latch reinforcement assembly 104, a left-hand and right-hand latch reinforcement 114, a left-hand and right-hand hinge reinforcement assembly 110, a left-hand and right-hand hinge support bracket 112, one or more striker assemblies 116, a left-hand and right-hand latch assembly 118, and the hinge and assist mechanism assembly 120 configured to couple the centergate 100 to the vehicle 130.

According to an exemplary embodiment, the left-hand and/or right-hand latch assemblies 118 may be configured to be mounted on the left and/or right sides of the centergate 100. According to an exemplary embodiment, the left-hand and/or right-hand latch assemblies 118 may be configured to be mounted on the left and/or right sides of the centergate 100 through the left-hand and right-hand latch reinforcement 114 inside the centergate 100. According to an exemplary embodiment, the left-hand and right-hand latch assemblies 118 may each be configured to be in contact with a corresponding left-hand or right-hand latch reinforcement 114. According to an exemplary embodiment, the one or more striker assemblies 116 may be configured to interlock with the left-hand and right-hand latch assemblies 118 to facilitate securing the centergate 100 in a closed position.

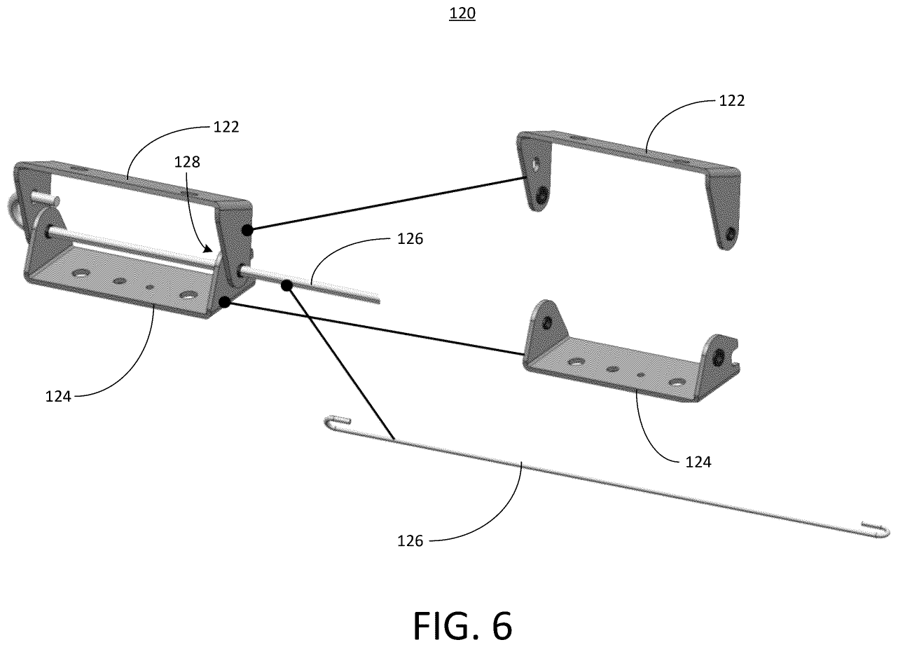

A hinge assembly 120 is shown, in more detail, in FIG. 6. As shown in FIG. 6, the hinge assembly 120 may comprise an upper bracket and bushing 122, a lower bracket and bushing 124, and a torsion bar 126 adjoining the upper bracket and bushing 122 and the lower bracket and bushing 124, forming a hinge 128 therebetween.

According to an exemplary embodiment, the hinge assembly 120 may be configured to be mounted on a lower side of the centergate 100. According to an exemplary embodiment, the hinge assembly 120 may be configured to be mounted on a lower side of the centergate 100 through the left-hand and right-hand hinge reinforcement assembly 110 and/or a left-hand and right-hand hinge support bracket 112 inside the centergate 100.

According to an exemplary embodiment, the hinge assembly 120 may be configured to serve as a hinge axis for opening and closing the centergate 100 from a lower side of the centergate 100. According to an exemplary embodiment, the torsion bar 126 that assists in opening and closing the centergate 100 may be added. According to an exemplary embodiment, instead of, or in addition to, the torsion bar 126, a coil spring and/or other suitable component may be incorporated.

According to an exemplary embodiment, the centergate 100 may be configured to be positioned in a closed position, separating the cab portion 134 and the bed portion 132 of the pickup truck 130, and an open position, connecting the cab portion 134 with the bed portion 132, enabling the cargo-carrying capacity of the pickup truck 130 to be increased, enabling the pickup truck 130 to carry more cargo 136.

According to an exemplary embodiment, the centergate 100 may be configured, when in the closed position, to form a secure barrier against weather, noise, and moving cargo 136.

According to an exemplary embodiment, the centergate 100 may be configured such that, when a significant cargo 136 mass suddenly impacts the centergate 100 in the closed position (e.g., when a vehicle is suddenly stopped (such as, e.g., when in a traffic collision), when a vehicle engages emergency vehicle braking, and/or during other suitable events), the centergate 100 may be configured to aid in preventing the cargo 136 from impacting the occupants in the pickup truck 130 (e.g., aid in preventing the cargo 136 from impacting the first row of seats in the pickup truck 130 and/or the second row of seats in the pickup truck 130).

According to an exemplary embodiment, the left-hand and right-hand reinforcement assemblies 104 may be positioned between, and coupled to, the left-hand and/or right-band latch assemblies 118 and the left-hand and right-hand hinge reinforcement assembly 110 and/or a left-hand and right-hand hinge support bracket 112, providing reinforcement to the centergate 100 in the event of a collision between the centergate 100 and the cargo 136, providing increased safety to occupants of the pickup truck 130.

According to an exemplary embodiment, the left-hand and right-hand reinforcement assemblies 104 may be coupled, directly or indirectly, at an angle (e.g., obliquely), to the left-hand and/or right-hand latch assemblies 118 and the left-hand and right-hand hinge reinforcement assembly 110 and/or a left-hand and right-hand hinge support bracket 112.

According to an exemplary embodiment, the impact beam 102 may be positioned between, and coupled to, the left-hand and right-hand reinforcement assemblies 104, providing extra reinforcement to the centergate 100 in the event of a collision between the centergate 100 and the cargo 136, providing increased safety to occupants of the pickup truck 130. According to an exemplary embodiment, the impact beam 102 may be coupled, directly or indirectly, to the left-hand or right-hand latch reinforcement assemblies 104.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A centergate system, comprising:
a vehicle comprising a cab portion and a bed portion; and
a centergate, positioned between the cab portion and the bed portion, the centergate comprising:
a centergate panel and an inner panel; and
housed within the centergate panel and the inner panel,
wherein the left-hand latch reinforcement assembly and the right-hand latch reinforcement assembly are coupled to left and/or right sides of the centergate and a lower side of the centergate.

2. The centergate system of claim 1, wherein:
the left-hand latch reinforcement assembly and the right-hand latch reinforcement assembly are positioned between, and coupled to:
the left-hand latch reinforcement and/or the right-hand latch reinforcement,
the left-hand hinge reinforcement assembly and/or right-hand hinge reinforcement assembly, and/or
a left-hand hinge support bracket and/or a right-hand hinge support bracket.

3. The centergate system of claim 1, wherein:
the left-hand latch reinforcement assembly and right-hand latch reinforcement assembly are coupled, directly or indirectly, at an angle to:
the left-hand latch hinge reinforcement and/or right-hand latch reinforcement assembly, and
the left-hand hinge reinforcement assembly and the right-hand hinge reinforcement assembly and/or a left-hand hinge support bracket and a right-hand hinge support bracket.

4. The centergate system of claim 1, wherein the impact beam is positioned between, and coupled to, the left-hand latch reinforcement assembly and the right-hand latch reinforcement assembly.

5. The centergate system of claim 1, wherein the centergate is configured to move between an open position and a closed position.

6. The centergate system of claim 5, wherein, in the closed position, the centergate is configured form a barrier between the cab portion and the bed portion.

7. The centergate system of claim 1, further comprising a hinge assembly configured to couple the centergate to the vehicle.

8. The centergate system of claim 1, wherein the impact beam is coupled to the left-hand latch reinforcement, the right-hand latch reinforcement

9. The centergate system of claim 1, wherein the centergate further comprises:
a left-hand hinge support bracket; and
a right-hand hinge support bracket.

10. The centergate system of claim 1, wherein the centergate further comprises one or more striker assemblies.

11. The centergate system of claim 1, wherein the centergate further comprises:
a left-hand latch assembly; and
a right-hand latch assembly.

12. The centergate system of claim 1, wherein the vehicle comprises a pickup truck.

13. A centergate, comprising:
an outer and inner panel; and
housed within the outer and inner panel:
a left-hand hinge reinforcement assembly;
a right-hand hinge reinforcement assembly; and
an impact beam positioned between, and coupled to, the left-hand latch reinforcement assembly and the right-hand latch reinforcement assembly,
wherein the centergate is configured to be positioned between a cab portion and a bed portion of a vehicle.

14. The centergate of claim 13, wherein the centergate is configured to move between an open position and a closed position.

15. The centergate of claim 13, further comprising a hinge assembly configured to enable the centergate to be coupled to the vehicle, the hinge assembly comprising:
an upper bracket and bushing;
a lower bracket and bushing; and
a torsion bar adjoining the upper bracket and bushing and the lower bracket and bushing, forming a hinge therebetween.

16. The centergate of claim 13, further comprising:
a left-hand latch reinforcement; and
a right-hand latch reinforcement.

17. The centergate system of claim 16, wherein the impact beam is coupled to the left-hand latch reinforcement, the right-hand latch reinforcement.

18. The centergate of claim 13, further comprising:
a left-hand hinge support bracket; and
a right-hand hinge support bracket.

19. The centergate of claim 13, further comprising one or more striker assemblies.

20. The centergate of claim 13, further comprising:
a left-hand latch assembly; and
a right-hand latch assembly.
